(19) United States
(12) Patent Application Publication
(10) Pub. No.: US 2018/0097406 A1
(43) Pub. Date: Apr. 5, 2018

(54) INDUCTIVE POWER TRANSMITTER

(71) Applicant: PowerbyProxi Limited, Auckland (NZ)

(72) Inventor: Liang Chen, Auckland (NZ)

(21) Appl. No.: 15/812,965

(22) Filed: Nov. 14, 2017

Related U.S. Application Data
(63) Continuation of application No. PCT/NZ2016/050074, filed on May 10, 2016.
(60) Provisional application No. 62/162,365, filed on May 15, 2015.

(51) Int. Cl. H02J 50/12; H02J 7/02

(52) U.S. Cl. CPC H02J 50/12; H02M 7/537; H02J 7/025

(57) ABSTRACT

An inductive power transmitter 2 comprising: a power transmitting coil 7 configured to receive an AC voltage; a capacitor 305 configured to connect in series with the coil 7; and a switch 303 configured to connect in series with the coil 7; wherein the switch 303 is switched based on a variable control effort parameter V_{ctrl} configured to determine the current through the coil 7.

This application is a continuation of International Application No. PCT/NZ2016/050074, filed on May 10, 2016, which claims the benefit of U.S. provisional patent application No. 62/162,365, filed on May 15, 2015 which are hereby incorporated by reference herein their entireties.

### FIELD

This invention relates generally to a converter, particularly though not solely, to a converter for an inductive power transmitter.

### BACKGROUND

Electrical converters are found in many different types of electrical systems. Generally speaking, a converter converts a supply of a first type to an output of a second type. Such conversion can include DC-DC, AC-AC, DC-AC and AC-DC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems are a well-known area of established technology (for example, wireless charging of electric toothbrushes) and developing technology (for example, wireless charging of handheld devices on a ‘charging mat’).

IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

There is increasing interest in inductively coupled power transfer systems in which the power transmitter includes an array of transmitter coils beneath a charging surface (commonly referred to as “charging mats”).

However currently available inductive power transmitters, especially array transmitters may still suffer from having large component counts and excess heat dissipation. Accordingly, the present invention may provide an improved inductive power transmitter or may provide the public with a useful choice.

### SUMMARY

According to an example embodiment there is provided an inductive power transmitter comprising:
a power transmitting coil configured to receive an AC voltage;
a capacitor configured to connect in series with the coil; and
a switch configured to connect in series with the coil;
wherein the switch is switched based on a variable control effort parameter configured to determine the current through the coil.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that the document is prior art, is validly combinable with other documents or forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of an inductive power transfer system;

FIG. 2 is a block diagram of an inverter;

FIG. 3 is a simplified circuit diagram of an inverter; and

FIG. 4 is a timing diagram of an inverter.

### DETAILED DESCRIPTION

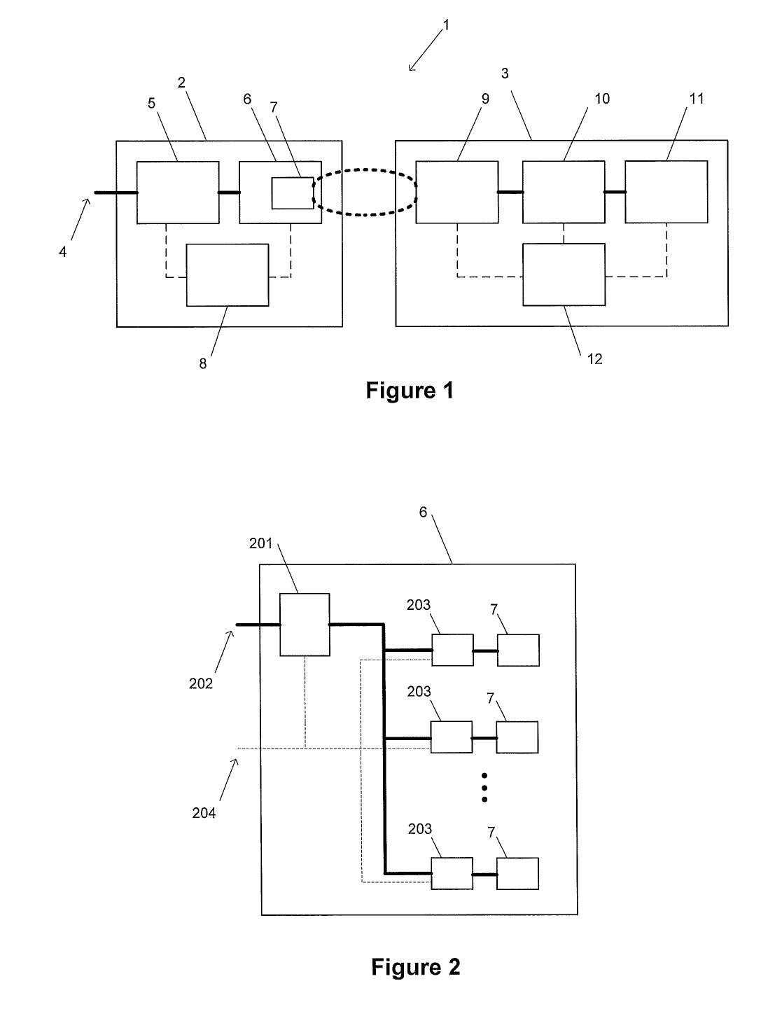

An inductive power transfer (IPT) system 1 is shown generally in FIG. 1. The IPT system 1 includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil or coils 7 may also be considered to be separate from the inverter 6. The transmitting coil or coils 7 may be connected to capacitors (not shown) either in parallel or series or some other combination to create a resonant circuit.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coil or coils 7, inductive power receiver detection and/or communications.

The inductive power receiver 3 includes a power pick-up stage 9 connected to power conditioning circuitry 10 that in turn supplies power to a load 11. The power pick-up stage 9 includes inductive power receiving coil or coils. When the coils of the inductive power transmitter 2 and the inductive power receiver 3 are suitably coupled, the alternating magnetic field generated by the transmitting coil or coils 7 induces an alternating current in the receiving coil or coils 9. The receiving coil or coils 9 may be connected to capacitors and additional inductors (not shown) either in parallel, series or some other combination, to create a resonant circuit. In some inductive power receivers, the receiver may include a controller 12 which may control tuning of the receiving coil or coils 7, operation of the power conditioning circuitry 10, characteristics of the load 11 and/or communications.

The power conditioning circuitry 10 is configured to convert the induced current into a form that is appropriate for load 11, and may perform for example power rectification, power regulation, or a combination of both.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. Other configurations may be used depending on the application. The use of the term “coil”, in either singular or plural, is not meant to be restrictive in this sense.

Current induced in the power pick-up stage 9 by transmitting coil or coils 7 will typically be high frequency AC at the frequency of operation of the transmitting coil or coils 7, which may be for example, 20 kHz, up to hundreds of megahertz or higher. For example it may be 110 kHz.

As mentioned above, the controller 8 may control power flow and/or selectively energize transmitting coils. Especially in the case of a “charging mat” transmitter, with an array of coils, selective coil activation may be beneficial. In prior systems this required either a separate inverter for each coil, or the use of an AC switch (two back-to-back MOSFET switches) for each coil, often with the source connected to ground. This may allow that only transmitting coils 7 nearby or underneath the power pick-up stage 9 are activated. If different groups of transmitting coils 7 can be selectively energized in this way, the energy efficiency, electromagnetic emissions, heat dissipation and the charge rate of the IPT system 1 can be improved.

Separate inverters for each coil are prohibitively expensive for most applications. The inventors determined that because the source needs to be ground referenced in a back-to-back MOSFET configuration in order for the gate control signals for the back-to-back transistors to also be ground referenced, this means that some inverter topologies such as a voltage sourced half-bridge inverter may not be used. Secondly, because the transmitter coil current must pass through both switches, the total conduction loss may be higher. Thirdly, because two power switches are required per AC regulator 203, the component count and bulk of the AC regulator 203 is large. Fourthly, because instantaneously interrupting the current that is flowing in transmitting coils 7 will create a voltage spike across the back-to-back transistors, the transistors may require snubbing circuits and/or switching at zero current crossing instants in order to protect the back-to-back transistors and to minimize switching losses.

In addition to turning a group of transmitting coils 7 on or off independently of other transmitting coils, the inventors determined that it may be advantageous for different transmitting coils 7 to be able to vary the strength of the magnetic field magnitudes they produce, independently from one another. This can be useful for charging two or more devices simultaneously on a charging mat or transmitter coil array, especially when the devices being charged have a different designs, casings, physical positions or power requirements from each other.

FIG. 2 shows an example embodiment of an inverter 6 to control the current in the transmitting coil or coils 7 independently from one another. The inverter 6 includes an AC source 201 which provides a base level AC voltage suitable for energising the transmitting coils 7 from a DC voltage 202 output from the converter 3. The current in each transmitting coil 7 is then regulated by an AC regulator 203. Control signals 204 between controller 8 and AC regulators 202 are provided for independent coil current regulation.

Because a separate AC regulator 203 is used for each independently controlled transmitting coil 7, improvements to the design of this AC regulator 203 can result in a significant improvements to the inductive power transmitter 2 as a whole.

The inverter 6 may use an AC source 201 connected in parallel with each AC regulator 203, such that each AC regulator 203 is provided with the same input AC voltage. Each AC regulator 203 may then be arranged in series with its associated transmitting coil or coils 7, so that by changing the impedance of the AC regulator 203, the current which flows through transmitting coil or coils 7 can be changed.

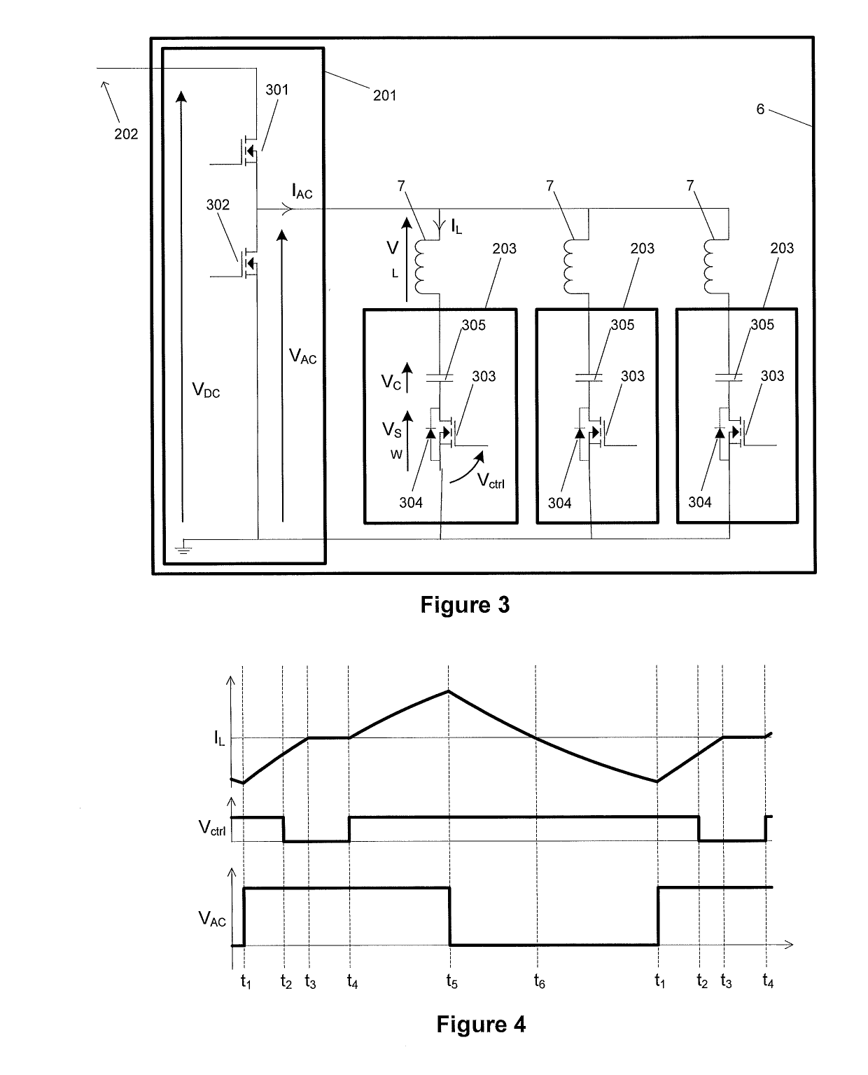

FIG. 3 shows an example circuit diagram of an inverter 6. The inverter 6 comprises an AC source 201 and three AC regulators 203. The DC voltage 202 V_{DC}, is supplied to the AC source 201. AC source 201 includes switch 301 and switch 302 connected in a half-bridge inverter configuration. The AC source 201 supplies an AC voltage V_{AC} to each AC regulator 203. Each AC regulator 203 comprises a FET 303, which includes body diode 304, and a capacitor 305. In this embodiment, capacitor 305 is chosen to be a large value so that it is substantially non-resonant with transmitting coil or coils 7 at the operating frequency. I_{L} is the current which flows in a specific transmitting coil 7, and is positive when flowing in the direction indicated by the I_{L} marker. V_{ctrl} is the signal which controls a specific FET 303, where “HIGH” corresponds to a FET 303 being switched ON and “LOW” corresponds to a FET 303 being switched OFF. V_{SW} is the voltage across FET 303. V_{L} is the voltage across transmitting coil or coils 7. V_{C} is the voltage across capacitor 305.

The value of the capacitor 305 can be chosen based on the intended operation of the inverter 6. If the transmitting coil or coils 7 are intended to function in a substantially non-resonant mode, so that the current I_{L} is largely equal to the AC source 201 output voltage V_{AC} divided by the impedance of the transmitting coil 7 at the operating frequency, then the capacitor 305 may be chosen to have a significantly smaller impedance than the coil at the operating frequency (e.g. X_{C}<X_{L}/10).

As an alternative, a more resonant tuning may be used when choosing capacitor 305. A more resonant tuning is useful if a more sinusoidal coil current I_{L} with lower high frequency harmonics is desired. This tuning is also useful if a larger V_{L} than the available inverter output voltage V_{AC} is required. To achieve a more resonant tuning, the impedance of the capacitor 305 may be chosen to be closer to that of the transmitting coil 7, at the operating frequency. Care however should be taken not to form perfect tuning at the operating frequency as that causes excessive current to flow in the inverter and could lead to system failure.

As a further alternative, it is possible to choose a capacitance value for capacitor 305 so that its impedance is larger than that of the transmitting coil 7. This will have the effect that the coil current I_{L} is 180 degrees out of phase from the normal coil current. However a capacitance value which gives a much larger impedance than the impedance of transmitting coil 7 is not normally used because this could limit the coil current and affect the inverter normal operation.

FET 303 will typically include an integral body diode 304. If a transistor type without a body diode, such as a bi-polar junction transistor (BJT) is used in place of FET 303, an additional diode should be added to the circuit in place of body diode 304. Because MOSFET devices typically have body diodes, an additional external diode in parallel with a MOSFET is not required. Therefore, using a MOSFET 303 is particularly advantageous and allows AC regulator 203 to have a low component count and small size. Because the body diode 304 of FET 303 will conduct when V_{SW} becomes negative by around 0.5V to 1.0V, FET 303 can block I_{L} current in only one direction, i.e., when V_{SW} is positive.

Even though, when by itself, FET 303 can block only positive I_{L} current, when FET 303 blocks this current, i.e., when V_{SW} is positive and FET 303 is off, less positive current I_{L} is able to flow forward through capacitor 305, on average. Since in steady state the sum of all positive and negative current through capacitor 305 must be zero, less positive I_{L} current results in less negative I_{L} current. Therefore, overall the AC regulator 203 is capable of regulating current flow in both directions. The advantages of this design for AC regulator 203 may include small size, ground referenced control inputs, low component count, simple control requirements, high efficiency and the ability to selectively block, partially allow or fully allow current to flow to each group of transmitting coil or coils 7.

By controlling when and for how long the FET 303 spends in an OFF state, the overall AC current amplitude through the AC regulator 203 can be controlled. The body diode 304 of the FET 303 or an external diode can be used to avoid the need for precise zero current detection when switching the FET 303 on and off. Soft switching can be achieved for both the switch on and switch off transitions, resulting in minimal switching losses.

Steady state voltage and current waveforms from within AC regulator 203 are shown in FIG. 4. These waveforms are for non-resonant tuning of transmitting coil or coils 7, though this switching method could be adapted for a more resonant tuning also.

At t₁, V_{AC} changes from 0V to +V_{DC}. At this time, I_{L} is at its most negative value and V_{ctrl} is positive so that FET 303 can conduct in the reverse direction, minimizing losses in body diode 304. Because capacitor 305 is non-resonant, the voltage V_{C} across it is approximately a DC value once the inverter 6 reaches a steady state. Therefore at this time, V_{L} is approximately equal to V_{AC} minus V_{C}, and at this time this is an approximately constant value. Therefore, current through transmitting coil or coils 7 increases at an approximately constant rate.

At t₂, V_{ctrl} changes from ON to OFF. This prepares the circuit for events at t₃. Because FET 303 is now OFF, current begins to flow through body diode 304 rather than in reverse through FET 303. The transition of V_{ctrl} from ON to OFF can be made any time I_{L} is negative, in other words, between t₆ and t₃, so precise timing is not required. However, because turning V_{ctrl} OFF forces current to flow through body diode 304, turning OFF too early may result in greater combined losses in FET 303 and body diode 304. In order to minimise switching and conduction losses, it is ideal to turn the FET 303 OFF just before I_{L} reaches zero. In practice this can be achieved by detecting the negative zero current crossing point of I_{L} (t₆) and implementing a delay time in controller 8 before the FET 303 is turned OFF. This delay time is governed by the fundamental IPT period and the intended control effort T_{blocking}, which is discussed in greater detail in the following paragraph.

At t₃, current I_{L} reaches zero. Because FET 303 is already OFF, current I_{L} remains at zero and zero current switch-off is achieved. V_{SW} becomes positive as FET 303 begins to block voltage. The controller 8 now waits for a period of time T_{blocking}=t₄− t₃, with longer amounts of time corresponding to lower RMS current I_{L} and therefore greater control effort. If T_{blocking} is zero, the amount of time the FET 303 will block positive I_{L} current is zero. Therefore, if T_{blocking} is zero, AC regulator 203 does not block current. This corresponds to minimum control effort. This minimum control effort situation is equivalent to FET 303 being ON continuously. Conversely, if T_{blocking} is half of the switching period or greater, the FET 303 blocks all positive I_{L} current, and so AC regulator 203 blocks all current, in the steady state. This maximum control effort situation is equivalent to FET 303 being OFF continuously.

At t₄, the period of time T_{blocking} has elapsed, so controller 8 turns V_{ctrl} from OFF to ON and FET 303 begins to conduct. Because V_{AC} is positive at +V_{DC} volts, V_{C} is an approximately DC value and V_{SW} is nearly zero, V_{L} is an approximately constant value. Therefore, I_{L} increases at an approximately constant rate. Because this switch transition occurs while current I_{L} is approximately zero amps, this is a zero current switch ON event, which helps to minimize switching loss.

At t₅, V_{AC} changes from +V_{DC} volts to 0 volts. This causes I_{L} to start decreasing from its most positive value at an approximately constant rate.

At t₆, I_{L} crosses zero amps. I_{L} continues to decrease at an approximately constant rate.

At t₁, the switching cycle repeats.

In the switching timing diagram shown in FIG. 4, FET 303 never changes from ON to OFF while I_{L} is positive, as to do so would mean interrupting current flowing in transmitting coil or coils 7, resulting in a voltage spike on FET 303. This could reduce the efficiency of inductive power transmitter 2, reduce the reliability of the AC regulator 203 and generate unwanted electromagnetic emissions. Therefore, with the circuit design shown in FIG. 3, the FET 303 should only be switched OFF while I_{L} is zero or negative. Detecting or predicting periods in which I_{L} is zero or negative is simpler and more reliable than detecting and switching at the exact zero crossing points of I_{L}, as might be required with other AC regulator 203 circuit topologies. However, the FET 303 may be switched ON at any time without causing voltage spikes.

The controller 8 may switch FET 303 OFF while current I_{L} is positive, for example due to an error or electronic noise. If this happens a snubber may be used to absorb voltage spikes on the FET 303 as the current flowing in transmitting coil or coils 7 is interrupted. While the AC regulator 203 is designed to work without a snubber, one may be added to protect against the unlikely event of mis-timings. For example, a simple dissipative snubber may be used.

Because a DC voltage must build up on capacitor 305 before it can block current flow through transmitting coil or coils 7, the AC regulator 203 does not turn from ON to OFF instantaneously. Similarly, because any DC voltage built up on capacitor 305 needs time to dissipate before it can conduct again, the AC regulator 203 cannot turn from OFF to ON instantaneously. However, over a number of cycles, a steady state DC voltage is established on capacitor 305 and control of AC current becomes possible with AC regulator 203.

The inventors determined that any AC regulation control techniques which are possible with a back-to-back MOSFET switch configuration are also possible with the proposed regulator 203 configuration, but that the performance of the proposed regulator 203 may be different. For example, when switching FET 303 ON and OFF the regulator 203 may take a few cycles to completely stop current flow I_{L}, rather than stopping current flow instantaneously. If there are compelling advantages for using different switch control methods, they can be implemented with the proposed inverter 6.

Some examples of different switch control methods, which can be used in place of or as a supplement to the method shown in FIG. 4 include:

A “Pulse skipping mode”, wherein FET 303 is left fully ON or OFF for one or more entire periods of AC voltage from AC source 201. For example, this could be useful when the control effort parameter is either very high (but not maximum) or very low (but not minimum), in order to avoid minimum off-time or minimum on-time rest limitations of gate driving hardware. This switch control method may produce a current I_{L} which has a varying amplitude.

A ratio of OFF periods to the total number of periods, wherein FET 303 is switched OFF for one or more periods and then switched ON for one or more periods, so that the ratio of OFF periods to the total number of periods corresponds to the control effort parameter. This switch control method may produce a current I_{L} which has a varying amplitude.

Driving FET 303 with a PWM signal at a fixed frequency other than V_{AC}, so that FET 303 is switched at a frequency that is above or below the frequency of V_{AC} with a duty cycle according to a control effort parameter. This avoids the need for I_{L} zero crossing detection or prediction. When this results in switching FET 303 OFF while I_{L} is positive, snubber circuitry can be used to limit EMI and voltage stress on FET 303. This switch control method may cause increased switching losses due to being neither zero current switched nor zero voltage switched. Snubbers are helpful in minimizing EMI and component stress but losses may be increased.

A number of alternative switch types may be used in place of FET 303 in AC regulator 203, including but not limited to metal oxide semiconductor field effect transistors (MOSFETs), bipolar junction transistors (BJTs) and insulated gate bipolar transistors (IGBTs). Also, optionally, a diode can be added in parallel with a switch. This is especially useful in cases where the switch does not include a body diode 304. In general, the switch and optional diode combination should be capable of selectively blocking and unblocking the flow of current in one direction, while also being capable of always allowing current flow in the opposing direction. Depending on switch driving requirements and placement position within the circuit, either P or N type devices can be used. It may be possible to integrate significant parts of the entire wireless power transmitter 2 or inverter 6 circuit onto a single integrated circuit, including control circuitry, DC-DC converters, DC-AC converters, AC regulators, gate driving circuits, phase sensing circuits and power switches.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power transmitter comprising:
a power transmitting coil arranged to receive an AC voltage;
a capacitor arranged to connect in series with the coil; and
a uni directional switch arranged to connect in series with the coil;
wherein the uni directional switch is switched based on a variable control effort parameter configured to determine the current through the coil.

2. The transmitter in claim 1 further comprising a plurality of power transmitting coils, each coil configured to form a series combination with a respective series capacitor and a respective series uni directional switch, and each series combination configured to connect in parallel with the other series combinations.

3. The transmitter in claim 2 further comprising an inverter connected in parallel with the plurality of series combinations, the inverter configured to provide the AC voltage to the plurality of series combinations, and each capacitor and switch configured to independently control the current through each respective coil.

4. The transmitter in claim 1 wherein the capacitor is configured for DC blocking.

5. The transmitter in claim 1 wherein a control signal provided to a gate of the uni directional switch is configured to be ground referenced.

6. The transmitter in claim 1 wherein the uni directional switch includes a reverse biased diode in parallel, and the switch is configured to be switched off while current is flowing in the diode.

7. The transmitter in claim 1 wherein the variable control effort parameter corresponds to how long the switch is configured to be switched during each cycle of the AC voltage.

8. The transmitter in claim 1 wherein the switch is configured for zero current switch on and off.

9. The transmitter in claim 1 wherein the uni directional switch is a MOSFET.

10. The transmitter in claim 1 wherein the coil and capacitor are non-resonant.

11. The transmitter in claim 3 wherein the inverter is a half bridge inverter.

12. The transmitter in claim 1 wherein the uni directional switch is not an AC switch or a bi-directional switch.
